(19) United States
(12) Patent Application Publication
(10) Pub. No.: US 2019/0349480 A1
(43) Pub. Date: Nov. 14, 2019

(54) INQUIRY PROCESSING METHOD, SYSTEM, TERMINAL, AUTOMATIC VOICE INTERACTIVE DEVICE, DISPLAY PROCESSING METHOD, TELEPHONE CALL CONTROLLING METHOD, AND STORAGE MEDIUM

(71) Applicant: SHARP KABUSHIKI KAISHA, Osaka (JP)

(72) Inventors: TORU UEDA, Sakai City (JP); TAKESHI MATSUSHITA, Osaka (JP); YURI IWANO, Osaka (JP); MAKOTO SHINKAI, Osaka (JP)

(21) Appl. No.: 16/291,662

(22) Filed: Mar. 4, 2019

(30) Foreign Application Priority Data
May 8, 2018 (JP) 2018-090157

(51) Int. Cl. H04M 3/58; H04M 3/51; H04M 3/493; G10L 15/22

(52) U.S. Cl. CPC H04M 3/58; H04M 3/5191; H04M 3/4936; G10L 2015/223; H04M 2250/58; H04M 2201/40; G10L 15/22

(57) ABSTRACT

The present invention provides a system which allows for a smooth conversation between a caller and a call-responder in a telephone call which has been transferred. The system (i) conducts, on the basis of a result of voice recognition of a speech voice of a user in a telephone call from the user, a search for response content of a response to be given to an inquiry made by the user in the telephone call, (ii) transmits an audio signal indicative of the response content to a user terminal (1), (iii) transfers the telephone call to a terminal (200), and (iv) causes information indicative of content of the inquiry to be displayed on a display section (230).

This Nonprovisional application claims priority under 35 U.S.C. § 119 on Patent Application No. 2018-090157 filed in Japan on May 8, 2018, the entire contents of which are hereby incorporated by reference.

### TECHNICAL FIELD

An aspect of the present invention relates to an automatic voice telephone call.

### BACKGROUND ART

There has been known an automatic response system for transferring, to an operator, a telephone call that is being had with a user with use of automated voice.

Further, there has been disclosed a system for having an automatic conversation with a user with use of a chat function (Patent Literature 1). This system receives, in a case where it is determined that an operator needs to intervene in the conversation, a speech text inputted by the operator.

### CITATION LIST

### Patent Literature

[Patent Literature 1]

Japanese Patent Application Publication, Tokukai, No. 2012-64073

### SUMMARY OF INVENTION

### Technical Problem

According to the technology disclosed in Patent Literature 1, the operator can check, with use of a terminal of the operator, content of a question which the user has told the system.

However, in a case where a telephone call with a user with use of automated voice is transferred by the automatic response system to the operator, the operator cannot recognize a question, request, or the like which the user has told the automatic response system. As a result, the user has to take the trouble to tell the question, request, or the like again.

An aspect of the present invention is accomplished in view of the foregoing problem, and has an object of providing an inquiry processing method and a system each of which allows for a smooth conversation between a caller and a call-responder in a telephone call which has been transferred.

### Solution to Problem

In order to attain the object, an inquiry processing method in accordance with the present invention is an inquiry processing method carried out by a system which receives an inquiry made by a caller through a telephone call, including the steps of: (a) identifying content of the inquiry on the basis of a result of voice recognition of a speech voice of the caller, the speech voice being obtained through the telephone call; (b) conducting a search for response content of a response to be made in response to the content of the inquiry; (c) transmitting an audio signal to a terminal of the caller, the audio signal being indicative of the response content obtained from the search; (d) transferring the telephone call to a terminal of a call-responder on the basis of a result of the search; and (e) causing information indicative of the content of the inquiry to be displayed on a display section which is incorporated in or connected to the terminal of the call-responder.

In order to attain the object, a system in accordance with the present invention is a system which receives an inquiry made by a caller through a telephone call, including: an automatic voice interactive device; and a terminal of a call-responder, the automatic voice interactive device including a control section, the control section of the automatic voice interactive device being configured to: identify content of the inquiry on the basis of a result of voice recognition of a speech voice of the caller, the speech voice being obtained through the telephone call; conduct a search for response content of a response to be made in response to the content of the inquiry; trigger, on the basis of a result of the search, a transfer of the telephone call to the terminal of the call-responder; and output the content of the inquiry so as to allow the terminal of the call-responder to cause information indicative of the content of the inquiry to be displayed in a state where a connection of the telephone call transferred has been established, the terminal of the call-responder including a display section and a control section, the control section of the terminal of the call-responder being configured to: carry out a process of receiving the transfer of the telephone call triggered by the automatic voice interactive device; and cause information indicative of the content of the inquiry to be displayed on the display section in a state where a connection of the telephone call transferred has been established.

In order to attain the object, a terminal in accordance with the present invention is a terminal including: a display section; and a control section, the control section being configured to: carry out a process of receiving a transfer of a telephone call with a caller, the transfer being triggered by an automatic voice interactive device; and cause information indicative of content of an inquiry made by the caller to be displayed on the display section in a state where a connection of the telephone call transferred has been established.

In order to attain the object, an automatic voice interactive device in accordance with the present invention is an automatic voice interactive device including a control section, the control section being configured to: identify content of an inquiry made by a caller, on the basis of a result of voice recognition of a speech voice of the caller, the speech voice being obtained through a telephone call; conduct a search for response content of a response to be made in response to the content of the inquiry identified; trigger, on the basis of a result of the search, a transfer of the telephone call to a terminal of a call-responder; and output the content of the inquiry so as to allow the terminal of the call-responder to cause information indicative of the content of the inquiry to be displayed in a state where a connection of the telephone call transferred has been established.

In order to attain the object, a display processing method in accordance with the present invention is a display processing method carried out by a terminal, including the steps of: carrying out a process of receiving a transfer of a telephone call with a caller, the transfer being triggered by an automatic voice interactive device; and causing information indicative of content of an inquiry made by the caller to be displayed on a display section in a state where a connection of the telephone call transferred has been established.

In order to attain the object, a telephone call controlling method in accordance with the present invention is a telephone call controlling method carried out by an automatic voice interactive device, including the steps of: identifying content of an inquiry made by a caller, on the basis of a result of voice recognition of a speech voice of the caller, the speech voice being obtained through a telephone call with the caller; carrying out a search for response content of a response to be made in response to the content of the inquiry identified; triggering, on the basis of a result of the search, a transfer of the telephone call with the caller to a terminal of a call-responder; and outputting the content of the inquiry so as to allow the terminal of the call-responder to cause information indicative of the content of the inquiry to be displayed in a state where a connection of the telephone call transferred has been established.

### Advantageous Effects of Invention

Thus, the system in accordance with an aspect of the present invention allows for a smooth conversation between a caller and a call-responder in the telephone call which has been transferred.

### BRIEF DESCRIPTION OF DRAWINGS

FIG. 1 is a functional block diagram illustrating an automatic voice interactive device and an operator terminal in accordance with each of Embodiments 1 to 3.

FIG. 2 is a view illustrating a configuration of a system in accordance with each of Embodiments 1 to 3.

FIG. 3 is a sequence diagram illustrating an example of an operation of the system in accordance with Embodiments 1 to 3.

FIG. 4 is a view illustrating an example of a conversation between the system in accordance with each of Embodiments 1 and 2 and a user.

FIG. 5 is a view illustrating an example of a conversation between the system in accordance with each of Embodiments 1 and 2, an operator, and a user.

FIG. 6 is a view illustrating an example of an operation screen displayed by an operator terminal in accordance with Embodiment 1.

FIG. 7 is a view illustrating an example of an operation screen displayed by an operator terminal in accordance with Embodiment 2.

FIG. 8 is a view illustrating an example of part of a tree structure indicative of scenarios of how an automatic voice interactive device in accordance with Embodiment 3 responds.

FIG. 9 is a block diagram illustrating an example hardware configuration of a computer that can be used as an automatic voice interactive device and an operator terminal.

### DESCRIPTION OF EMBODIMENTS

### Embodiment 1

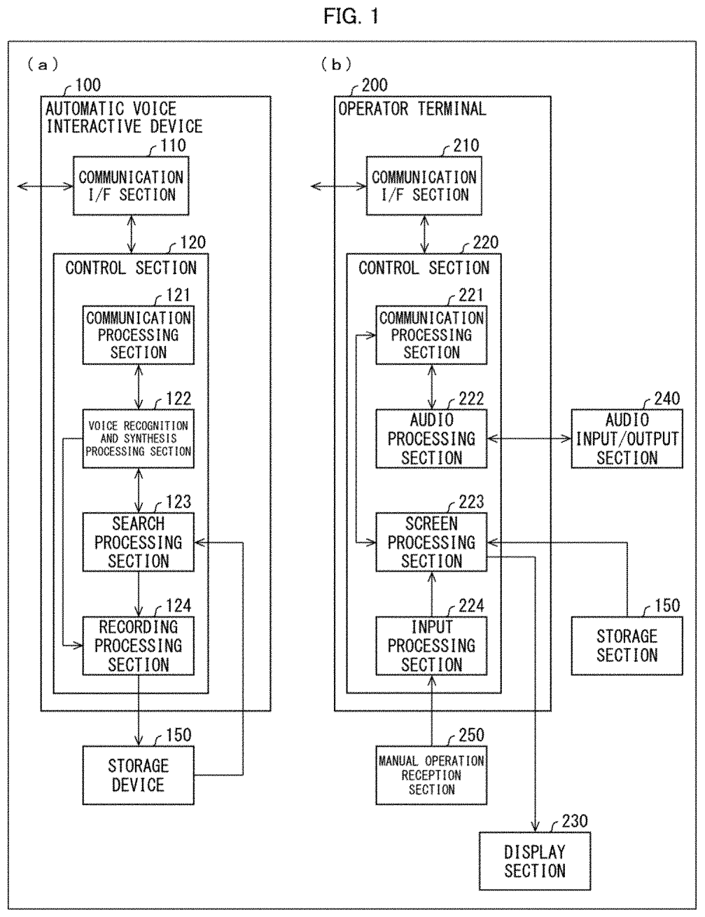

The following description will discuss Embodiment 1 of the present invention with reference to FIGS. 1 through 6.

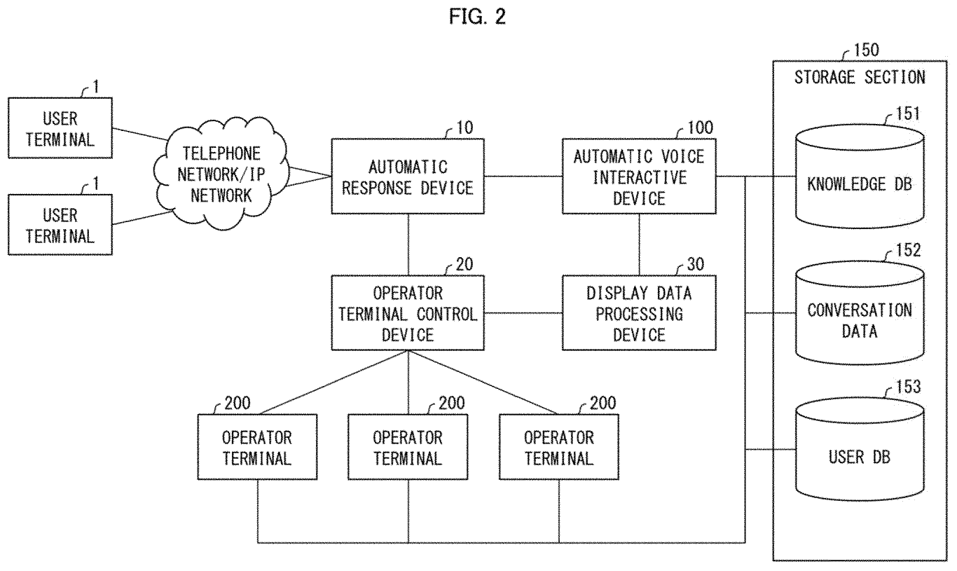

A system in accordance with Embodiment 1 is a system which receives an inquiry made by a caller (user) through a telephone call. An example configuration of the system will be discussed below with reference to FIGS. 1 and 2.

[1. Configuration of System]

FIG. 1 is a functional block diagram of an automatic voice interactive device 100 and an operator terminal 200 in accordance with Embodiment 1. FIG. 2 is a view illustrating a configuration of the system in accordance with Embodiment 1.

As illustrated in FIG. 2, the system includes an automatic response device 10, an operator terminal control device 20, a display data processing device 30, the automatic voice interactive device 100, a storage device 150, user terminals 1, and operator terminals 200.

(Automatic Response Device 10)

The automatic response device 10 receives an incoming telephone call from a user terminal 1 and carries out a process for establishing a call connection between the automatic voice interactive device 100 and the user terminal 1. The automatic response device 10, at the request of the automatic voice interactive device 100, causes a telephone call between the automatic voice interactive device 100 and a user to be transferred.

(Operator Terminal Control Device 20)

In a case where the operator terminal control device 20 receives, from the automatic response device 10, a request to call out an operator who can attend to a telephone call, the operator terminal control device 20 selects an appropriate operator (call-responder) from among a plurality of candidate operators, and transfers the telephone call to an operator terminal 200 of the operator selected.

(Display Data Processing Device 30)

The display data processing device 30 provides information necessary for an operator terminal 200 to generate an operation screen.

(Automatic Voice Interactive Device 100)

The automatic voice interactive device 100 is a device which autonomously has a conversation with a user.

As illustrated in (a) of FIG. 1, the automatic voice interactive device 100 includes a communication interface (communication I/F section) 110 and a control section 120.

The control section 120 centrally controls the automatic voice interactive device 100. The control section 120 serves as a communication processing section 121, a voice recognition and synthesis processing section 122, a search processing section 123, and a recording processing section 124.

The communication processing section 121 carries out a process for establishing a call connection with the user terminal 1. The communication processing section 121 carries out a process of receiving a voice signal indicative of a speech voice of a user and a process of transmitting a voice signal indicative of content (response content) of a response to be made by the automatic voice interactive device 100.

In a case where a condition (transfer condition), under which it is determined that answering an inquiry (i.e., solving a question) is not possible, is met, the communication processing section 121 requests the automatic response device 10 to transfer the telephone call to an operator.

The voice recognition and synthesis processing section 122 carries out voice recognition with respect to a speech voice of a user and also generates a synthetic sound from a character string for answering the user. That is, every time the user speaks, the voice recognition and synthesis processing section 122 generates, on the basis of the speech voice as an input, character information indicative of content of the speech, and generates a voice signal indicative of response content obtained by a search conducted by the search processing section 123.

The search processing section 123, on the basis of a result of a voice recognition, searches a knowledge DB 151 (described later) for response content of a response to be given to a speech (an inquiry or the like) of a user, and transfers the response content obtained from the search to the voice recognition and synthesis processing section 122.

The recording processing section 124 records, every time the voice recognition and synthesis processing section 122 generates the character information, records the character information generated in the storage device (storage section) 150 (described later).

(Storage Device 150)

The storage device 150 holds various DBs in each of which information for generating an operation screen is stored.

The knowledge DB 151 is a database in which, for each predefined speech content, response content corresponding to the speech content is recorded.

Conversation data 152 is character information which is accumulated by the recording processing section 124 in the storage device 150. The conversation data 152 is recorded for each user every time the user makes a telephone call. Further, the conversation data 152 is stored so as to be associated with a telephone number and/or an ID of the user and time at which the telephone call between the user and the automatic voice interactive device 100 started.

A user DB 153 is a database which stores therein various information (a telephone number, an ID, and the like) of a user who is registered in the system.

Other than the above, the storage device 150 also holds a product database (not illustrated) which stores therein information of a product and/or a service (hereinafter referred to as “product etc.”) handled by a business operator which uses the system. Further, the storage device 150 also holds a purchase database (not illustrated) which stores therein, for each user, an ID, a telephone number, and an order history of the user are recorded.

(Operator Terminal 200)

An operator terminal 200 is a terminal which is used by an operator in order to have a conversation with a user.

As illustrated in (b) of FIG. 1, the operator terminal 200 includes a communication interface (communication I/F section) 210 and a control section 220.

The control section 220 centrally controls the operator terminal 200. The control section 220 serves as a communication processing section 221, an audio processing section 222, a screen processing section 223, and an input processing section 224.

The communication processing section 221 carries out a process for establishing a call connection with the user terminal 1. The communication processing section 221 carries out a process of receiving a voice signal indicative of a speech voice of a user and a process of transmitting a voice signal indicative of content (response content) of a response to be made by an operator. Further, the communication processing section 221 carries out a process of receiving information for generating an operation screen.

The audio processing section 222 outputs a speech voice of a user via an audio input/output section 240. The audio input/output section 240 is constituted by a microphone and a speaker. A speech voice of the operator is taken in by the audio input/output section 240, and the audio processing section 222 supplies the communication processing section 221 with a voice signal indicative of the speech voice of the operator.

The screen processing section 223 generates an operation screen and causes the operation screen generated to be displayed on a display section (display device) 230. The screen processing section 223 generates, as the operation screen, a screen which contains information indicative of content of the above inquiry.

Further, the screen processing section 223 carries out a process of updating the operation screen in accordance with a manual operation (e.g., an operation with use of a keyboard or a mouse) performed by the operator.

The input processing section 224 notifies the screen processing section 223 of content of an operation performed with use of a manual operation reception section 250 (a keyboard, a mouse, and/or the like).

Note that the display section 230, the audio input/output section 240, and the manual operation reception section 250 may each be incorporated in the operator terminal 200, or may be a device provided separately from the operator terminal 200.

[2. Process Flow]

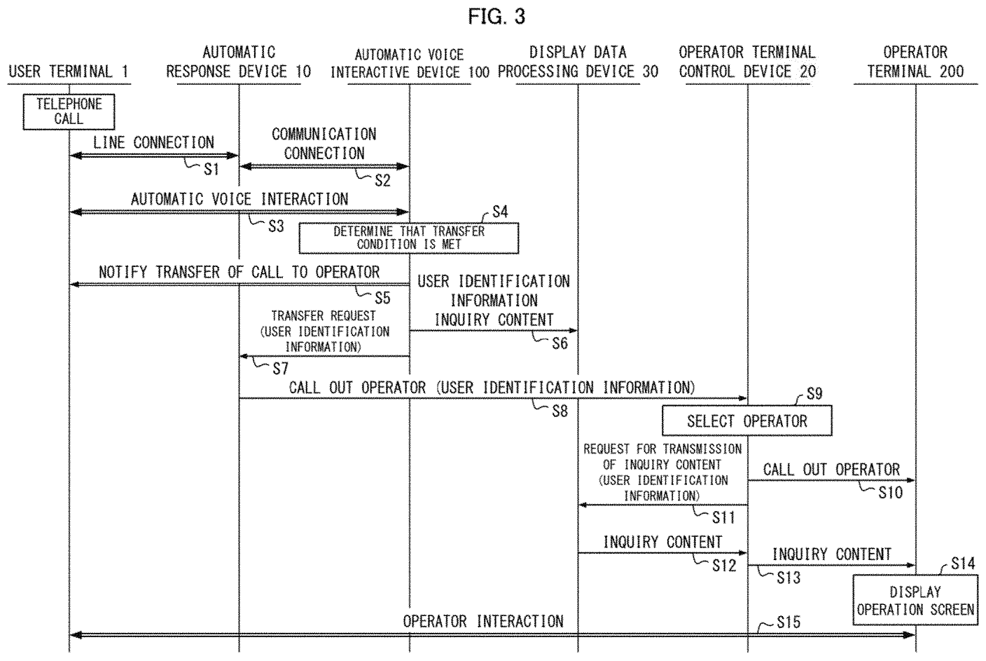

With reference to FIGS. 3 through 6, the following description will discuss a flow of processes carried out by the system.

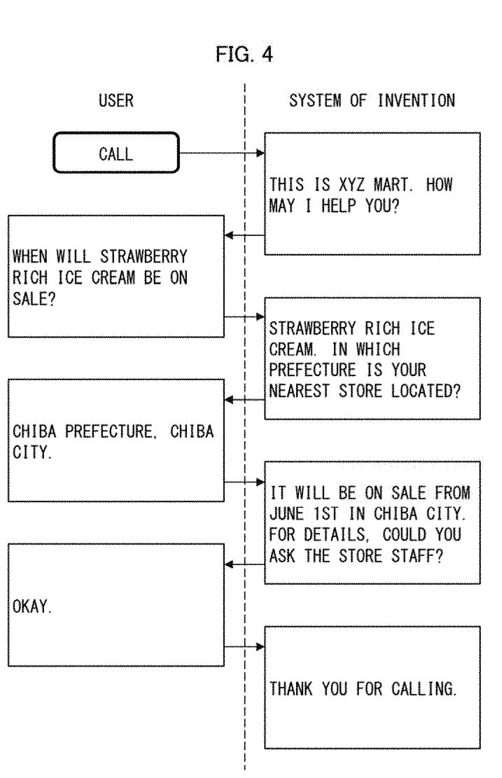

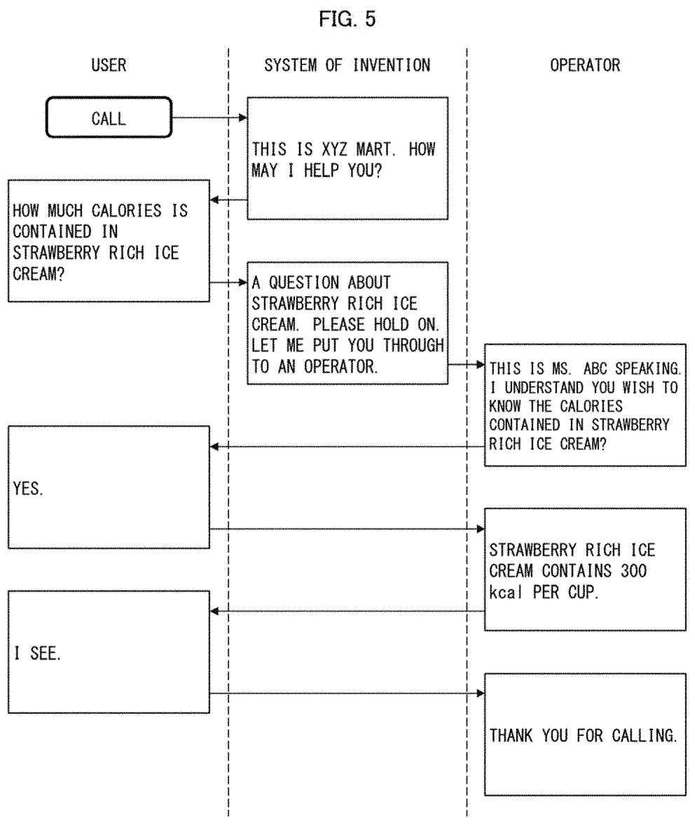

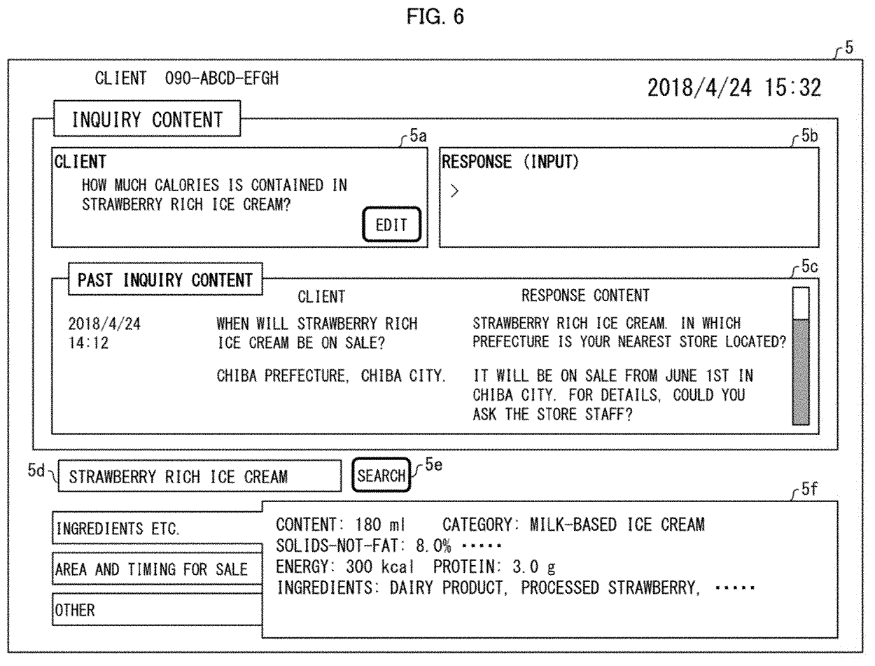

FIG. 3 is a sequence diagram illustrating an example of an operation of the system. FIG. 4 is a view illustrating an example of a conversation between the system and a user. FIG. 5 is a view illustrating an example of a conversation between the system, an operator, and a user. FIG. 6 is a view illustrating an example of an operation screen displayed by an operator terminal 200.

(S1)

In a case where a user makes a telephone call by inputting, to the user terminal 1, a telephone number of the system, the user terminal 1 and the automatic response device 10 establish a line connection between each other at step S1.

(S2)

At step S2, the automatic response device 10 and the automatic voice interactive device 100 establish a communication connection between each other.

(S3)

At step S3, the automatic voice interactive device 100 and the user have a conversation with each other, in which automated voice is utilized. That is, every time the user speaks, the voice recognition and synthesis processing section 122 (i) carries out voice recognition with respect to a speech voice, (ii) generates, on the basis of a result of the voice recognition, character information indicative of content of the speech (inquiry), and (iii) records the character information generated in the storage section 150. Then, on the basis of the character information generated, the search processing section 123 searches the knowledge DB 151 for response content of a response to be given to the inquiry, and the communication processing section 221 transmits, to the user terminal 1, a signal of a voice indicative of the response content obtained from the search.

In other words, step S3 includes a step of identifying the content of the inquiry on the basis of the result of the voice recognition of the caller's speech voice obtained through the telephone call, a step of searching for response content of a response to be made in response to the content of the inquiry identified, and a step of transmitting, to the terminal of the caller, a voice signal indicative of the response content obtained by the search.

At step S3, in a case where the automatic voice interactive device 100 successfully answers the inquiry (i.e., successfully solves the question), the telephone call with the user is ended without carrying out processes at S4 and subsequent steps.

For example, in a conversation illustrated in FIG. 4, an inquiry “When will Strawberry Rich Ice Cream be on sale?” is made. In response to the inquiry, the automatic voice interactive device 100 successfully answers to the effect that “It will be on sale from June 1st.” Accordingly, the conversation with the user is ended without carrying out processes at S4 and subsequent steps.

(S4)

At step S4, in a case where the search processing section 123 obtains response content “Let me put you through to an operator.” from the knowledge DB 151 on the basis of a result of voice recognition of content of the last speech given by the user, it is determined that the transfer condition is met.

For example, in a conversation illustrated in FIG. 5, an inquiry “How much calories is contained in Strawberry Rich Ice Cream?” is received. In response, the automatic voice interactive device 100 obtains, from a search, response content “Let me put you through to an operator.”

Accordingly, the automatic voice interactive device 100 determines that the transfer condition is met. The automatic voice interactive device 100 can determine that the transfer condition is met, also in a case where no response content is found as a result of a search of the knowledge DB 151 for response content corresponding to the content of the inquiry (in a case where the search fails).

(S5)

At step S5, the communication processing section 121 transmits, to the user terminal 1, a signal of a voice indicative of “Let me put you through to an operator.”

(S6)

At step S6, the communication processing section 121 reads out the content of the user's inquiry from the storage section 150 (conversation data 152), and transmits the content to the display data processing device 30 together with user identification information. Note that the user identification information is constituted by a telephone number of the user (for example, “090-ABCD-EFGH” in FIG. 6) and a user ID in Embodiment 1. Alternatively, the user identification information may be one of the telephone number of the user and the user ID. Further, the communication processing section 121 may search the user DB 153 for user information such as the name, address, email address, and the like of the user on the basis of the telephone number or the like, and transfer a search result thus obtained to the display data processing device 30 together with the user identification information.

(S7)

At step S7, the communication processing section 121 triggers a transfer of the telephone call with the user to an operator terminal 200. That is, the communication processing section 121 transmits, to the automatic response device 10, a transfer request for transferring the telephone call to an operator. The transfer request contains the user identification information.

Note that the order in which the processes of steps S5 through S7 are carried out is not particularly limited. For example, the automatic voice interactive device 100 may carry out the processes of step S7, step S6, and step S5 in this order.

(S8)

At step S8, the automatic response device 10 transmits, to the operator terminal control device 20, a call-out request for calling out an operator. The call-out request contains the user identification information.

(S9)

At step S9, the operator terminal control device 20 selects one operator terminal 200 from among a plurality of operator terminals 200.

Note that a criterion in accordance with which one operator terminal 200 is selected may be any criterion.

For example, the operator terminal control device 20 may select, from among operator terminals 200 of operators who are currently available, one operator terminal 200 randomly or on the basis of the telephone number of the user.

(S10)

At step S10, the operator terminal control device 20 transmits, to the operator terminal 200 selected at step S9, a signal for calling out an operator.

In a case where the operator carries out an operation of responding to the signal, a connection of the telephone call transferred is established between the operator terminal 200 and the user terminal 1.

(S11)

At step S11, the operator terminal control device 20 transmits, to the display data processing device 30, a transmission request for requesting transmission of the content of the inquiry made by the user. The transmission request contains the user identification information.

Note that the order in which the processes of steps S10 through S11 are carried out is not particularly limited. For example, the operator terminal control device 20 may carry out the processes of step S11 and step S10 in this order.

(S12)

At step S12, the display data processing device 30 transmits, to the operator terminal control device 20, information indicative of the content of the inquiry made by the user.

(S13)

At step S13, the operator terminal control device 20 transmits, to the operator terminal 200 selected at step S9, the information indicative of the content of the inquiry made by the user.

(S14)

At step S14, the screen processing section 223 generates an operation screen 5 as illustrated in FIG. 6, and causes the operation screen 5 generated to be displayed on the display section 230. As illustrated in FIG. 6, the information indicative of the content of the inquiry (i.e., the content of the inquiry made in the current telephone call) is displayed in a predetermined region 5a within the operation screen 5.

In addition to the region 5a, the operation screen 5 includes a region 5b in which character information, which is obtained from voice recognition of the content spoken by the operator, is shown, a region 5c in which information indicative of content of an inquiry made by the same user in a telephone call in the past, is shown, a group of UIs 5d and 5e for conducting a search for information related to a product or the like, and a region 5f in which information obtained from the search is shown.

Note that the screen processing section 223 may extract a keyword from the information indicative of the content of the inquiry made by the user, carry out, with use of the keyword extracted, automatically conduct the search of the product database for the information related to the product or the like, and display a result of the search in the region 5f.

(S15)

At step S15, the operator, while looking at the operation screen 5, answers the inquiry made by the user.

[3. Advantages of System]

As described above, the system in accordance with Embodiment 1 is a system which receives an inquiry made by a caller through a telephone call.

The automatic voice interactive device 100 (the recording processing section 124) records information indicative of the inquiry in the storage section 150. On the basis of a result of voice recognition of a voice in the telephone call, the automatic voice interactive device 100 (the search processing section 123) conducts a search for response content of a response to be given to the inquiry. Further, the automatic voice interactive device 100 (the communication processing section 121) transmits, to a terminal 1 of the caller, a voice signal indicative of the response content (e.g., response content “Let me put you through to an operator.”).

The automatic response device 10 transfers the telephone call to a terminal 200 of an operator. The operator terminal 200 (the screen processing section 223), in a state where a connection of the telephone call transferred has been established, refers to the information and causes an operation screen 5, which contains the information in a region 5a, to be displayed on the display section 230.

This allows the operator to immediately recognize, as soon as the telephone call is transferred, the content of the inquiry made by the caller in the telephone call.

Thus, the system in accordance with Embodiment 1 can be deemed to allow for a smooth conversation between the caller and the call-responder (operator) in a telephone call transferred from the automatic response device 10.

Note that the operator who has recognized the content of the inquiry can quickly obtain an answer to the inquiry by referring to the search result (relevant information which is relevant to the content of the call) shown in the region 5f. That is, the system in accordance with Embodiment 1 allows preventing the user from suffering irritation caused by being unable to receive an answer immediately.

### Embodiment 2

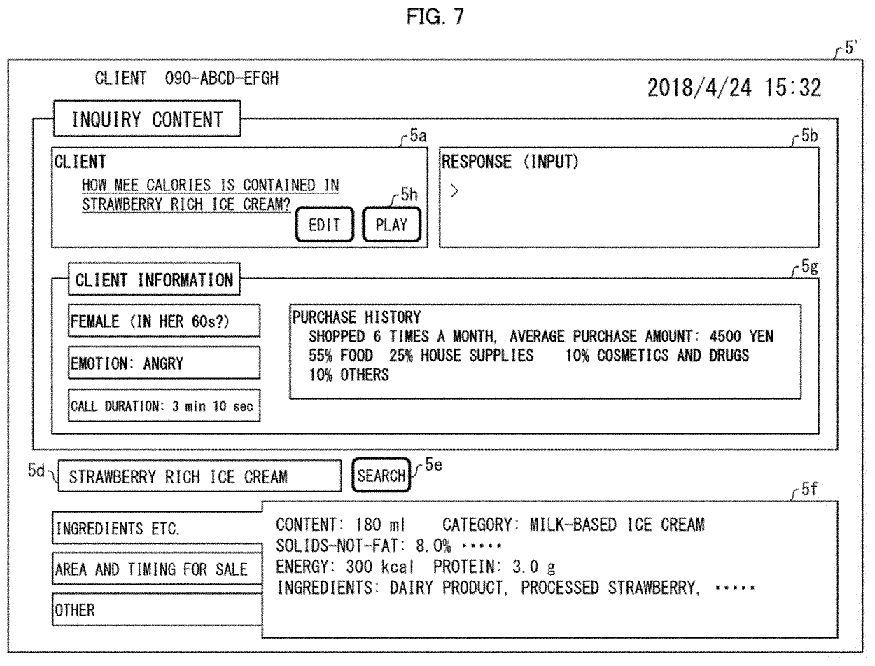

Further with reference to FIG. 7, the following description will discuss Embodiment 2 of the present invention.

For easy explanation, the same reference signs will be given to members each having the same function as a member described in Embodiment 1, and descriptions on such a member will be omitted.

Embodiment 2 also employs the configurations illustrated in FIGS. 1 and 2. A flow of processes carried out by a system in accordance with Embodiment 2 is basically the same as that for the system in accordance with Embodiment 1. Note, however, that a voice recognition and synthesis processing section 122 and an audio processing section 222 have features below, and the system carries out additional processes related to those functions in some steps.

That is, the voice recognition and synthesis processing section 122 has a function of analyzing a voice signal indicative of a remark made by a user (caller) so as to estimate an attribute (e.g., age, sex, and membership type) and an emotional state of the user.

The voice recognition and synthesis processing section 122, at step S3, estimates the attribute and/or the emotional state of the user on the basis of a result of voice recognition.

At step S6, information (hereinafter also referred to as “attribute information and/or the like”) indicative of the attribute and/or the emotional state of the user, in addition to user identification information and content of an inquiry, is transmitted to a display data processing device 30. At steps S12 and S13, the attribute information and/or the like of the user is/are transmitted in addition to the content of the inquiry made by the user.

A screen processing section 223, with reference to a telephone number of the user, identifies time at which the telephone call started and also searches a purchase database so as to cause a search result (e.g., a purchase history of the user) to be displayed, together with the attribute information and/or the like and a duration of the telephone call, in a region 5g within an operation screen 5′ as illustrated in FIG. 7.

Note that in Embodiment 2, the content of the inquiry transmitted in steps S6, S12, and S13 includes (i) a recorded voice signal obtained by recording a speech voice indicative of the content of the inquiry made by the user and (ii) character information obtained by carrying out voice recognition with respect to the speaking voice.

Further, the audio processing section 222 has a function of reproducing the recorded voice indicative of the content of the inquiry of the user.

That is, at steps S14 and S15, in a case where an operator operates a play button 5h, the audio processing section 222 outputs, via an audio input/output section 240, the recorded voice indicated by the recorded voice signal transmitted at step S13.

Even in a case where the voice recognition has poor accuracy and the character information therefore does not indicate the content of the inquiry clearly, the operator can play the recorded voice so as to confirm the content of the inquiry made by the user.

Note that the operation screen 5′ may include a UI component for adjusting a speed of playing the recorded voice (playing the recorded voice in a speed higher or lower than that of an actual speech).

[Advantages of System]

The system in accordance with Embodiment 2 has the following advantage in addition to the advantages of the system in accordance with Embodiment 1.

That is, an automatic voice interactive device 100 (the voice recognition and synthesis processing section 122) obtains information (attribute information and/or the like) related to a caller (user) on the basis of a result of voice recognition.

The screen processing section 223, in a state where a connection of a telephone call with the user has been established, causes information (the attribute information and/or the like and a purchase history) related to the user to be displayed.

This allows the operator to act appropriately in the telephone call with the user with reference to the information related to the user.

### Supplementary Note

An operator terminal control device 20 may be configured to select an operator from among a plurality of candidate operators on the basis of the information related to the user at step S9. In such a case, at steps S7 and S8, the attribute information and/or the like of the user may also be transmitted in addition to the user identification information.

Further, a storage device 150 may hold a database which stores therein information related to operators. The information related to operators may be, for example, information for identifying years of experience of each operator, a character of the operator, a field in which the operator is skilled, an operator terminal 200 used by the operator, and the like.

At step S9, in a case where the attribute information and/or the like shows that the user is angry, the operator terminal control device 20 may identify, with reference to the database, an operator terminal 200 of an operator having a certain number or more of years of experience, and select the operator terminal 200 identified. Additionally or alternatively, in a case where the attribute information and/or the like show that the user is a premium member (excellent member), the operator terminal control device 20 may select an operator terminal 200 of an operator whose years of experience is on a certain level of more.

Further, the operator terminal control device 20 may carry out steps S11 and S12 between steps S8 and S9 and carry out steps S10 and S13 after step S9.

In this case, the operator terminal control device 20 may identify, at step S9, the user's inquiry to be an inquiry related to a certain topic (e.g., a product such as a food product, a service such as a point system). Then, the operator terminal control device 20 may identify, with reference to the database, an operator terminal 200 of an operator skilled in handling with inquiries related to the certain topic, and select the operator terminal 200 selected.

What topic an inquiry of a user is related to is identifiable by comparing a keyword included in character information indicative of the inquiry and a dictionary of each field.

### Embodiment 3

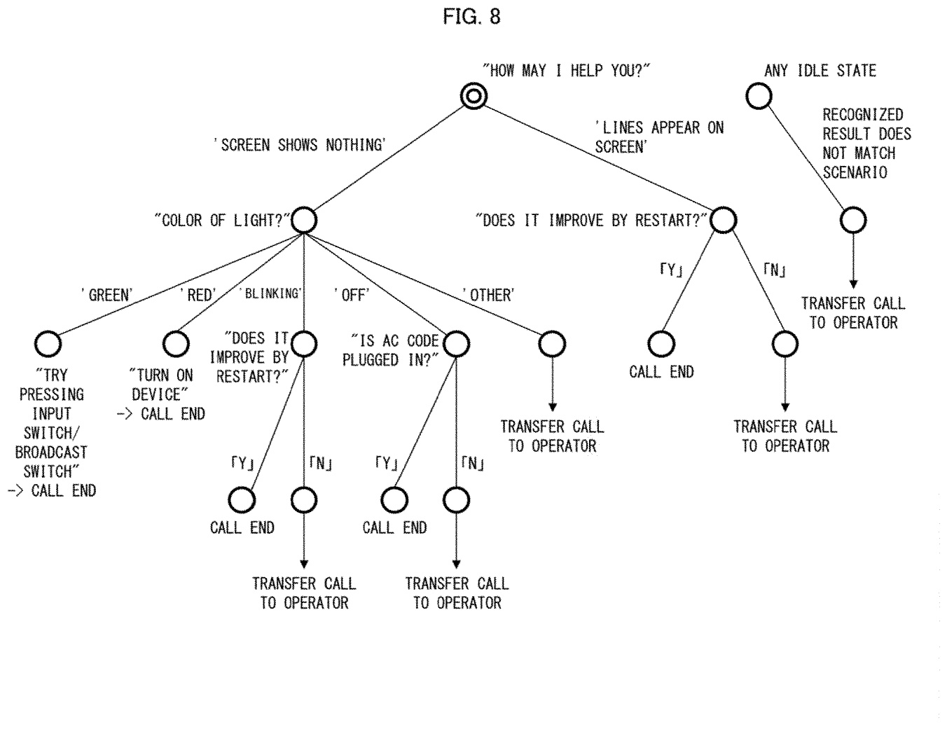

Further with reference to FIG. 8, the following description will discuss Embodiment 3 of the present invention.

FIG. 8 is a view illustrating an example of part of a tree structure indicative of scenarios of how an automatic voice interactive device 100 responds.

For easy explanation, the same reference signs will be given to members each having the same function as a member described in each of Embodiments 1 and 2, and descriptions on such a member will be omitted.

Embodiment 3 also employs the configurations illustrated in FIGS. 1 and 2. In Embodiment 3, a flow of processes carried out by a system is basically the same as the system in accordance with Embodiment 1. However, Embodiment 3 differs from the systems in accordance with Embodiments 1 and 2 in the following point.

That is, at step S3, a voice recognition and synthesis processing section 122 generates character information which allows recognizing approximately an entire interaction between a user and the automatic voice interactive device 100 in an automatic voice interaction.

Among a plurality of (nine) scenarios shown by the tree structure illustrated in FIG. 8, a scenario in which a telephone call is transferred to an operator will be discussed as an example. That is, the following discusses an example scenario in which, in response to a question “How may I help you?”, the user answers “The screen shows nothing.”, and in response to a question asking the color of a light, the user answers “Blinking.”, and in response to a question asking whether or not the situation improves by a restart, the user answers “It does not improve by the restart.”

In this scenario, the voice recognition and synthesis processing section 122, at step S3, generates character information indicative of that “The screen shows nothing, the light does not blink, and the situation does not improve by a restart” on the basis of (i) the questions given by the automatic voice interactive device 100 and (ii) a result of voice recognition of the answers given by the user to the respective questions.

The same is basically true of other scenarios involving a transfer of a telephone call to an operator, among the plurality of (nine) scenarios shown by the tree structure illustrated in FIG. 8.

For example, in a case where the user answers “The screen shows nothing.” in response to the question “How may I help you?” and answers “Purple.” in response to the question asking the color of the light, the voice recognition and synthesis processing section 122 generates character information indicative of that “The screen shows nothing.”

Subsequently at steps S6, S12, and S13, the character information generated at step S3 is transmitted, in place of the character information indicative of the content of the inquiry in Embodiments 1 and 2.

Note that in a case where the content of a speech of the user does not correspond to any of the scenarios, character information indicative of a result of voice recognition of the remark made by the user is transmitted as it is at steps S6, S12, and S13.

Subsequently at step S14, a screen processing section 223 causes an operation screen, which contains the character information, to be displayed.

### Advantages of System

As described above, in Embodiment 3, the voice recognition and synthesis processing section 122 generates character information which allows recognizing approximately an entire interaction between a user and the automatic voice interactive device 100 in an automatic voice interaction. Further, in a state where a connection of a telephone call with the user has been established, the screen processing section 223 causes the character information to be displayed.

Thus, the system in accordance with Embodiment 3 allows a conversation between a caller and an operator in a telephone call, which has been transferred and is in a connected state, to be even more smooth as compared with the system in accordance with Embodiment 1 in which only content of an inquiry is displayed on the operation screen 5 as a remark of the user in the telephone call.

### Supplementary Note on Embodiments 1 Through 3

The conversation data 152 may contain not only character information indicative of an interaction between a user and the automatic voice interactive device 100 but also character information indicative of an interaction between the user and a call-responder (in Embodiments 1 through 3, an operator). This character information may be character information which is indicative of each remark made by the user toward the call-responder and/or each remark made by the call-responder toward the user.

In this case, at step S15, the character information indicative of the interaction between the user and the call-responder may be recorded by the audio processing section 222 in the storage section 150 as part of the conversation data 152.

### Modified Examples of Embodiments 1 through 3

### Modified Example 1

In Embodiments 1 to 3, a telephone call between a user and the automatic voice interactive device 100 is transferred to an operator. However, the present invention is not limited to Embodiments 1 to 3.

For example, the present invention encompasses in its scope a system which attends to an inquiry made by a user to a delivery company regarding a delivery status of a parcel and in which a telephone call between the user and the automatic voice interactive device 100 is transferred to a terminal of a driver (a call-responder) who delivers the parcel. In this case, the terminal of the driver serves as the operator terminal 200 (the terminal of the call-responder) in Embodiments 1 through 3.

In this case, the terminal of the driver may include a component for selecting between (i) accepting a transfer of the telephone call and (ii) requesting that the automatic voice interactive device 100 carry out automatic response again.

Further, the terminal of the driver may include a component for requesting, after an operation of accepting a transfer of the telephone call is carried out, that the automatic voice interactive device 100 carry out automatic response again. Operating the component may allow the automatic voice interactive device 100 to be informed that the inquiry made by the user has been answered.

These components may be realized by software or may be realized by hardware.

In a case where the driver has carried out an operation of requesting that the automatic voice interactive device 100 carry out automatic response again, the terminal of the driver may make a request to the automatic response device 10 that the telephone call with the user be re-transferred to the automatic voice interactive device 100. Then, on the basis of the request, the automatic response device 10 may re-transfer the telephone call with the user to the automatic voice interactive device 100.

This allows the driver to determine whether or not to start (or continue) the telephone call with the user.

Note that in a case where the driver has answered the inquiry made by the user, the automatic voice interactive device 100, upon receiving a re-transfer of the telephone call, may start the telephone call with the user in order to receive another inquiry from the user. Alternatively, in a case where the driver did not accept a transfer of the telephone call, the automatic voice interactive device 100 may request the automatic response device 10 to transfer the telephone call to an operator.

### Modified Example 2

The systems in accordance with Embodiment 1 to 3 are each configured such that an operator has a conversation with a user only through a telephone call.

However, the present invention is not limited to such a configuration.

That is, the operation screen may include (i) a chat function and (ii) a user interface (UI) component for transmitting, to the user terminal 1, URL information for accessing the chat function. For example, the UI component may be a UI component for transmitting URL information to a certain chat application installed in the user terminal 1.

Accordingly, when having a conversation with the user, the operator can make a combined use of a chat and phone call so as to have the conversation more smoothly.

For example, in a case where the user has requested for detailed ingredient information of “Strawberry Rich Ice Cream” shown in the region 5f of the operation screen 5, 5′, the operator may use a copy-and-paste function so as to paste the ingredient information onto a chat screen. This allows the operator to tell the detailed ingredient information to the user quickly.

Note that there is a chat function which is designed to display, on a chat screen, both content that was discussed by the user in the past and content (an inquiry) that is currently being discussed by the user.

In a system in which only the chat function with such a design is used in an interaction with the user, it may be difficult for the operator to recognize the content of the inquiry immediately.

The system of Modified Example 2 not only allows the operator to immediately recognize, on the operation screen, content of an inquiry made by the user but also allows the operator to reduce, with use of the chat function, time between recognizing the content of the inquiry and answering the inquiry.

### Modified Example 3

In Embodiments 1 to 3, a telephone call between a user and the automatic voice interactive device 100 is basically transferred to an operator.

However, in a case where none of the operators is currently available, it is not possible for the operator terminal control device 20 to select an operator at step S9. In this case, at step S9, the operator terminal control device transmits, to the automatic response device 10, a notification to the effect that it is impossible to transfer the telephone call to an operator.

The automatic response device 10 transfers the notification to the automatic voice interactive device 100.

In this case, the communication processing section 121 transmits, to the user terminal 1, (i) a notification to the effect that the user can input a call-back request and (ii), if the call-back request is inputted, a notification to the effect that an operator will later make a telephone call to the user.

In a case where the user inputs a call-back request, the user terminal 1 transmits the call-back request to the automatic voice interactive device 100. The recording processing section 124 records, in the storage section 150 and as part of call-back request information, a telephone number of the user terminal 1 and character information indicative of an interaction between the user and the automatic voice interactive device 100 in the telephone call.

The screen processing section 223 of each operator terminal 200 has a function of reading out the call-back request information from the storage section 150 and causing the call-back request information to be displayed on the display section 230.

Note that the call-back request information may include information which is indicative of time at which a call-back request was made. This allows each operator to recognize time during which each call-back request has been on hold, and accordingly allows the operator to prioritize attending to a call-back request that has been on hold for a long time.

In a case where the operator carries out, with use of the manual operation reception section 250, an operation of making a telephone call to a telephone number included in the call-back request information and a connection of a telephone call is established, the screen processing section 223 causes, for example, the operation screen as illustrated in FIG. 5 or 6 to be displayed on the display section.

### Modified Example 4

The systems of Embodiments 1 to 3 are each a system which is based on the premise that a language used by a user (a caller) in a telephone call is identical to that used by an operator in the telephone call. Note, however, that the present invention is not limited to these systems.

That is, the present invention encompasses in its scope a system which can attend to a user's inquiry even in a case where a language used by the user in the phone call is different from a language (hereinafter, “predetermined language”) used by the operator in the phone call. Examples of the predetermined language encompass Japanese.

In such a system, the voice recognition and synthesis processing section 122 may identify the language used by the user, on the basis of a result of voice recognition of a speech voice of the user. For example, in a case where the user uses a language (e.g., Chinese) other than the predetermined language in the phone call, the voice recognition and synthesis processing section 122 may identify the language used by the user in the phone call to be Chinese.

Then, in a case where the voice recognition and synthesis processing section 122 has identified the language used by the user in the phone call to be a language other than the predetermined language, the voice recognition and synthesis processing section 122 may carry out the following processes.

That is, the voice recognition and synthesis processing section 122 may translate character information, which is indicative of content of the speech (inquiry), from the language used by the user in the phone call to the predetermined language.

Then, on the basis of the character information translated into the predetermined language, the voice recognition and synthesis processing section 122 may conduct a search of the knowledge DB 151 for response content, which is recorded in the predetermined language, of a response to be given to the inquiry.

Further, the voice recognition and synthesis processing section 122 may translate the response content, which has been obtained from the search, from the predetermined language to the language used by the user in the telephone call and transmit, to the user terminal 1, a signal of a voice that is (i) in the language into which the response content has been translated and (ii) indicative of the response content.

As described above, the voice recognition and synthesis processing section 122 may be configured to use a translation function in order to carry out the above processes at step S3.

Accordingly, even an operator who does not understand the language used by the user in the phone call can have the phone call with the user smoothly.

Note that in Modified Example 4, the information which is transmitted at steps S6, S12, and S13 and which is indicative of the content of the inquiry made by the user is information indicative of the content of the inquiry in the predetermined language. Accordingly, even an operator who does not understand the language used by the user in the phone call can recognize, immediately through the operation screen, the content of the inquiry made by the user.

Further, Modified Example 4 may be combined with Modified Example 2.

In this case, when the user has inputted, to the chat screen of the user terminal 1, a message in a language other than the predetermined language, the operator terminal 200 (the control section 220 which executes the chat application) may translate the message into the predetermined language. Then, the control section 220 may cause the message thus translated to be displayed on the chat screen displayed on the display section 230.

Likewise, the chat application installed in the user terminal 1 may translate a message, which is in the predetermined language and has been inputted by the operator, into the language used by the user in the chat.

Then, the chat application may cause the message thus translated to be displayed on the chat screen of the user terminal 1.

Accordingly, even an operator who does not understand the language used by the user in the phone call can have a smooth interaction with the user with use of the phone call and the chat. Further, advantageously, an operator who understands a foreign language used by the user in the phone call is also free of pressure which may otherwise be felt by the operator when communicating with the user in the foreign language in the phone call and in the chat.

### Embodiment 4

In Embodiments 1 through 3, a plurality of servers (the automatic response device 10, the automatic voice interactive device 100, the operator terminal control device 20, and the display data processing device 30) are used. Note, however, that it is also possible to employ a configuration in which a single server having the functions of all of these servers is used. Alternatively, it is also possible to use a greater number of serves than the above plurality of servers. In a case of employing a plurality of servers, the plurality of servers may be managed by an identical business operator or may be managed by respective different business operators.

### Embodiment 5

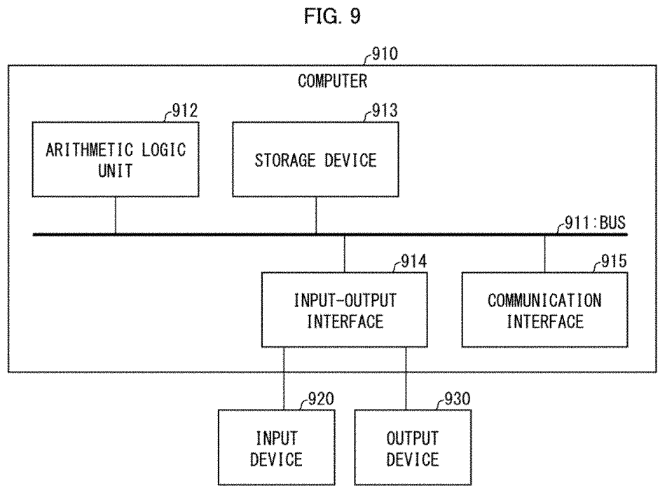

The blocks of the automatic voice interactive device 100 and the operator terminal 200 can be realized by a logic circuit (hardware) provided in an integrated circuit (IC chip) or the like or can be alternatively realized by software. In the latter case, it is possible to configure each of the automatic voice interactive device 100 and the operator terminal 200 with use of a computer as illustrated in FIG. 9.

FIG. 9 is a block diagram illustrating an example configuration of a computer 910 that can be used as the automatic voice interactive device 100 or the operator terminal 200. The computer 910 includes an arithmetic device 912, a storage device 913 (a main storage device and/or an auxiliary storage device), an input/output interface 914, and a communication interface 915 which are connected to each other via a bus 911. The arithmetic device 912 and the storage device 913 can be, for example, a processor (e.g., a central processing unit: CPU), and a random access memory (RAM) and a hard disk drive, respectively. The input/output interface 914 is connected with (i) an input device 920 with which a user inputs various information to the computer 910 and (ii) an output device 930 via which the computer 910 outputs various information to the user. The input device 920 and the output device 930 can be incorporated into the computer 910 or can be devices which are (externally) connected to the computer 910. For example, the input device 920 can be a keyboard, a mouse, a touch sensor, or the like, and the output device 930 can be a display, a printer, a speaker, or the like. Alternatively, it is possible to employ a device having functions of both the input device 920 and the output device 930, such as a touch panel in which a touch sensor and a display are integrated. The communication interface 916 is an interface via which the computer 910 communicates with an external device.

The storage device 913 stores various programs for causing the computer 910 to function as the automatic voice interactive device 100 or the operator terminal 200. The arithmetic device 912 loads, on the main storage device, the various programs stored in the auxiliary storage device and executes a command included in each of the various programs so that the computer 910 functions as each section of the automatic voice interactive device 100 or the operator terminal 200. Note that a storage medium which is included in the auxiliary storage device for recording information such as the various programs only needs to be a computer-readable “non-transitory tangible medium” and can be, for example, a tape, a disk, a card, a semiconductor memory, a programmable logic circuit, or the like. The main storage device can be omitted in a computer that can execute the program stored in the storage medium without loading the program on the main storage device. The number of each of the above devices (i.e., the arithmetic device 912, the main storage device, the auxiliary storage device, the input/output interface 914, the communication interface 915, the input device 920, and the output device 930) can be one or can be two or more.

The various programs can be obtained from outside of the computer 910. In this case, the various programs can be obtained via any transmission medium (such as a communication network or a broadcast wave). The present invention can also be achieved in the form of a computer data signal in which the various programs are embodied via electronic transmission and which is embedded in a carrier wave.

[Recap]

An inquiry processing method in accordance with Aspect 1 of the present invention is an inquiry processing method carried out by a system which receives an inquiry made by a caller through a telephone call, including the steps of: (a) identifying content of the inquiry on the basis of a result of voice recognition of a speech voice of the caller, the speech voice being obtained through the telephone call; (b) conducting a search for response content of a response to be made in response to the content of the inquiry; (c) transmitting an audio signal to a terminal (a user terminal 1) of the caller, the audio signal being indicative of the response content obtained from the search; (d) transferring the telephone call to a terminal of a call-responder (an operator, a driver) on the basis of a result of the search; and (e) causing information indicative of the content of the inquiry to be displayed on a display section 230 which is incorporated in or connected to the terminal of the call-responder.

In Aspect 2 of the present invention, the inquiry processing method in accordance with Aspect 1 may be arranged such that the inquiry processing method further includes the step of re-transferring the telephone call, which has been transferred to the terminal of the call-responder (the driver), back to a transfer origin (an automatic voice interactive device 100) in a case where a predetermined action with respect to the operator terminal 200 of the call-responder has been detected.

In Aspect 3 of the present invention, the inquiry processing method in accordance with Aspect 1 or 2 may be arranged such that the inquiry processing method further includes the step of reproducing, triggered by an operation (an operation with respect to a play button 5h) carried out by the call-responder (the operator), a voice indicative of the content of the inquiry.

In Aspect 4 of the present invention, the inquiry processing method in accordance with any one of Aspects 1 to 3 may be arranged such that the inquiry processing method further includes the steps of: conducting, on the basis of the result of the voice recognition, a search for relevant information which is relevant to content of the telephone call; and causing the relevant information to be displayed on the terminal of the call-responder.

In Aspect 5 of the present invention, the inquiry processing method in accordance with any one of Aspects 1 to 4 may be arranged such that the inquiry processing method further includes the steps of: obtaining information (attribute information and/or the like) related to the caller on the basis of the result of the voice recognition; and selecting the call-responder from among a plurality of candidate call-responders on the basis of the information related to the caller.

In Aspect 6 of the present invention, the inquiry processing method in accordance with any one of Aspects 1 to 5 may be arranged such that the inquiry processing method further includes the steps of: identifying, on the basis of the result of the voice recognition, a language used by the caller in the telephone call; and in a case where the language used by the caller in the telephone call is a language other than a predetermined language, translating the content of the inquiry to the predetermined language, wherein in the case where the language used by the caller in the telephone call is a language other than the predetermined language, the step (b) searches for the response content which is response content of a response to be made in response to the content of the inquiry translated to the predetermined language and which is recorded in the predetermined language, in the case where the language used by the caller in the telephone call is a language other than the predetermined language, the inquiry processing method further includes the step of translating the response content from the predetermined language to the language used by the caller in the telephone call, and in the case where the language used by the caller in the telephone call is a language other than the predetermined language, the step (c) transmits, to the terminal of the caller, the audio signal which is an audio signal indicative of the response content translated to the language used by the caller in the telephone call.

A system in accordance with Aspect 7 of the present invention is a system which receives an inquiry made by a caller through a telephone call, including: an automatic voice interactive device 100; and a terminal (an operator terminal 200) of a call-responder, the automatic voice interactive device 100 including a control section 120, the control section 120 of the automatic voice interactive device 100 being configured to: identify content of the inquiry on the basis of a result of voice recognition of a speech voice of the caller, the speech voice being obtained through the telephone call; conduct a search for response content of a response to be made in response to the content of the inquiry; trigger, on the basis of a result of the search, a transfer of the telephone call to the operator terminal 200; and output the content of the inquiry so as to allow the operator terminal 200 to cause information indicative of the content of the inquiry to be displayed in a state where a connection of the telephone call transferred has been established, the operator terminal 200 including a display section 230 and a control section 220, the control section 220 of the operator terminal 200 being configured to: carry out a process of receiving the transfer of the telephone call triggered by the automatic voice interactive device 100; and cause information indicative of the content of the inquiry to be displayed on the display section 230 in a state where a connection of the telephone call transferred has been established.

A terminal (an operator terminal 200) in accordance with Aspect 8 of the present invention is a terminal including: a display section 230; and a control section 220, the control section 220 being configured to: carry out a process of receiving a transfer of a telephone call with a caller, the transfer being triggered by an automatic voice interactive device 100; and cause information indicative of content of an inquiry made by the caller to be displayed on the display section 230 in a state where a connection of the telephone call transferred has been established.

An automatic voice interactive device 100 in accordance with Aspect 9 of the present invention is an automatic voice interactive device including a control section 110, the control section 110 being configured to: identify content of an inquiry made by a caller, on the basis of a result of voice recognition of a speech voice of the caller, the speech voice being obtained through a telephone call; conduct a search for response content of a response to be made in response to the content of the inquiry identified; trigger, on the basis of a result of the search, a transfer of the telephone call to a terminal (an operator terminal 200) of a call-responder; and output the content of the inquiry so as to allow the operator terminal 200 to cause information indicative of the content of the inquiry to be displayed in a state where a connection of the telephone call transferred has been established.

A display processing method in accordance with Aspect 10 of the present invention is a display processing method carried out by a terminal (an operator terminal 200), including the steps of: carrying out a process of receiving a transfer of a telephone call with a caller, the transfer being triggered by an automatic voice interactive device 100; and causing information indicative of content of an inquiry made by the caller to be displayed on a display section 230 in a state where a connection of the telephone call transferred has been established.

A telephone call controlling method in accordance with Aspect 11 of the present invention is a telephone call controlling method carried out by an automatic voice interactive device 100, including the steps of: identifying content of an inquiry made by a caller, on the basis of a result of voice recognition of a speech voice of the caller, the speech voice being obtained through a telephone call with the caller; carrying out a search for response content of a response to be made in response to the content of the inquiry identified; triggering, on the basis of a result of the search, a transfer of the telephone call with the caller to a terminal (an operator terminal 200) of a call-responder; and outputting the content of the inquiry so as to allow the operator terminal 200 to cause information indicative of the content of the inquiry to be displayed in a state where a connection of the telephone call transferred has been established.

The terminal according to the foregoing aspects of the present invention may be realized by a computer. In this case, the present invention encompasses: a control program which program causes a computer to operate as the foregoing sections (software elements) of the terminal so that the terminal can be realized by the computer; and a computer-readable storage medium storing the control program therein.

The automatic voice interactive device according to the foregoing aspects of the present invention may be realized by a computer. In this case, the present invention encompasses: a control program which program causes a computer to operate as the foregoing sections (software elements) of the automatic voice interactive device so that the automatic voice interactive device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: user terminal (terminal of caller)
100: automatic voice interactive device
120: control section
150: storage device (storage section)
200: operator terminal (terminal of call-responder)
220: control section
230: display device (display section)

1. An inquiry processing method carried out by a system which receives an inquiry made by a caller through a telephone call, comprising the steps of:
(a) identifying content of the inquiry on the basis of a result of voice recognition of a speech voice of the caller, the speech voice being obtained through the telephone call;
(b) conducting a search for response content of a response to be made in response to the content of the inquiry;
(c) transmitting an audio signal to a terminal of the caller, the audio signal being indicative of the response content obtained from the search;
(d) transferring the telephone call to a terminal of a call-responder on the basis of a result of the search; and
(e) causing information indicative of the content of the inquiry to be displayed on a display section which is incorporated in or connected to the terminal of the call-responder.

2. The inquiry processing method as set forth in claim 1, further comprising the step of re-transferring the telephone call, which has been transferred to the terminal of the call-responder, back to a transfer origin in a case where a predetermined action with respect to the terminal of the call-responder has been detected.

3. The inquiry processing method as set forth in claim 1, further comprising the step of reproducing, triggered by an operation carried out by the call-responder, a voice indicative of the content of the inquiry.

4. The inquiry processing method as set forth in claim 1, further comprising the steps of:
conducting, on the basis of the result of the voice recognition, a search for relevant information which is relevant to content of the telephone call; and
causing the relevant information to be displayed on the terminal of the call-responder.

5. The inquiry processing method as set forth in claim 1, further comprising the steps of:
obtaining information related to the caller on the basis of the result of the voice recognition; and
selecting the call-responder from among a plurality of candidate call-responders on the basis of the information related to the caller.

6. The inquiry processing method as set forth in claim 1, further comprising the steps of:
identifying, on the basis of the result of the voice recognition, a language used by the caller in the telephone call; and
in a case where the language used by the caller in the telephone call is a language other than a predetermined language, translating the content of the inquiry to the predetermined language, wherein
in the case where the language used by the caller in the telephone call is a language other than the predetermined language, the step (b) searches for the response content which is response content of a response to be made in response to the content of the inquiry translated to the predetermined language and which is recorded in the predetermined language,
in the case where the language used by the caller in the telephone call is a language other than the predetermined language, the inquiry processing method further comprises the step of translating the response content from the predetermined language to the language used by the caller in the telephone call, and
in the case where the language used by the caller in the telephone call is a language other than the predetermined language, the step (c) transmits, to the terminal of the caller, the audio signal which is an audio signal indicative of the response content translated to the language used by the caller in the telephone call.

7. A system which receives an inquiry made by a caller through a telephone call, comprising:
an automatic voice interactive device; and
a terminal of a call-responder,
the automatic voice interactive device including a control section,
the control section of the automatic voice interactive device being configured to:
identify content of the inquiry on the basis of a result of voice recognition of a speech voice of the caller, the speech voice being obtained through the telephone call;
conduct a search for response content of a response to be made in response to the content of the inquiry;
trigger, on the basis of a result of the search, a transfer of the telephone call to the terminal of the call-responder; and
output the content of the inquiry so as to allow the terminal of the call-responder to cause information indicative of the content of the inquiry to be displayed in a state where a connection of the telephone call transferred has been established,
the terminal of the call-responder including a display section and a control section,
the control section of the terminal of the call-responder being configured to:
carry out a process of receiving the transfer of the telephone call triggered by the automatic voice interactive device; and
cause information indicative of the content of the inquiry to be displayed on the display section in a state where a connection of the telephone call transferred has been established.

8. A terminal comprising:
a display section; and
a control section,
the control section being configured to:
carry out a process of receiving a transfer of a telephone call with a caller, the transfer being triggered by an automatic voice interactive device; and
cause information indicative of content of an inquiry made by the caller to be displayed on the display section in a state where a connection of the telephone call transferred has been established.

9. An automatic voice interactive device comprising a control section,
the control section being configured to:
identify content of an inquiry made by a caller, on the basis of a result of voice recognition of a speech voice of the caller, the speech voice being obtained through a telephone call;
conduct a search for response content of a response to be made in response to the content of the inquiry identified;
trigger, on the basis of a result of the search, a transfer of the telephone call to a terminal of a call-responder; and
output the content of the inquiry so as to allow the terminal of the call-responder to cause information indicative of the content of the inquiry to be displayed in a state where a connection of the telephone call transferred has been established.

10. A display processing method carried out by a terminal, comprising the steps of:
carrying out a process of receiving a transfer of a telephone call with a caller, the transfer being triggered by an automatic voice interactive device; and
causing information indicative of content of an inquiry made by the caller to be displayed on a display section in a state where a connection of the telephone call transferred has been established.

11. A telephone call controlling method carried out by an automatic voice interactive device, comprising the steps of:
identifying content of an inquiry made by a caller, on the basis of a result of voice recognition of a speech voice of the caller, the speech voice being obtained through a telephone call with the caller;
carrying out a search for response content of a response to be made in response to the content of the inquiry identified;
triggering, on the basis of a result of the search, a transfer of the telephone call with the caller to a terminal of a call-responder; and
outputting the content of the inquiry so as to allow the terminal of the call-responder to cause information indicative of the content of the inquiry to be displayed in a state where a connection of the telephone call transferred has been established.

12. A computer-readable non-transitory recording medium in which a control program for (i) causing a computer to function as a terminal recited in claim 8 and (ii) causing the computer to function as the control section is stored.

13. A computer-readable non-transitory recording medium in which a control program for (i) causing a computer to function as an automatic voice interactive device recited in claim 9 and (ii) causing the computer to function as the control section is stored.
